(19) United States
(12) Patent Application Publication
(10) Pub. No.: US 2014/0316853 A1
(43) Pub. Date: Oct. 23, 2014

(54) Determine a Product from Private Information of a User

(71) Applicant: Philip Scott Lyren, Bangkok (TH)

(72) Inventor: Philip Scott Lyren, Bangkok (TH)

(21) Appl. No.: 13/868,108

(22) Filed: Apr. 23, 2013

(51) Int. Cl. G06Q 30/02

(52) U.S. Cl. CPC G06Q 30/0202
USPC 705/7.31

(57) ABSTRACT

A user agent of a user obtains private information that is restricted from being disclosed to third parties except the user and the user agent. This private information is analyzed to predict a product that the user desires to purchase. An identity of the user and an identity of the product are provided to a third party without disclosing any of the private information to the third party.

### BACKGROUND

Internet privacy is a concern for many Internet users. A wide range of products and services exist to assist users in maintaining their personal information private. These services prevent third parties from collecting and analyzing information that users intend to keep private. This information includes valuable data that is not available to third parties when properly maintained as being private.

### BRIEF DESCRIPTION OF THE DRAWINGS

FIG. 1 is a computer system in accordance with an example embodiment.

FIG. 2 is a method to determine a product that a user desires based on information obtained about the user in accordance with an example embodiment.

FIG. 3 is a method to sell a product determined from private information of a user in accordance with an example embodiment.

FIG. 4 is a method to purchase a product determined from information about a user in accordance with an example embodiment.

FIG. 5 is a method to authorize an electronic device and/or software program to purchase a product for a user in accordance with an example embodiment.

FIG. 6 is a method to disclose to a social network a product that a user desires in accordance with an example embodiment.

FIG. 7 is a method to interact with a user to improve determining a product that is based on private information about the user in accordance with an example embodiment.

FIG. 8 is an electronic device in accordance with an example embodiment.

### SUMMARY OF THE INVENTION

One example embodiment is a method that obtains private information about a user and determines that the private information is restricted from being disclosed to any party except the user and a user agent of the user. The private information is analyzed to predict a product that the user desires to purchase. An identity of the user and an identity of the product are provided to an advertiser without disclosing any of the private information to a third party including the advertiser. An electronic device of the user displays an advertisement for the product received from the advertiser

### DETAILED DESCRIPTION

Example embodiments include systems, apparatus, and methods that determine a product that a user desires based on private information obtained about the user. An action is then taken on the product without revealing the private information to third parties.

Users have privacy concerns about their private information. For example, users are often reluctant and/or unwilling to allow third parties to collect and/or review their private information since users do not trust such third parties. Furthermore, users may feel exploited or betrayed if this private information is collected and stored, made public, sold without knowledge of the users, or disseminated without knowledge or authorization of the user. Users can take various actions and precautions to protect their private information, such as deleting information (e.g., deleting emails), using privacy settings to restrict companies from monitoring Internet activity (e.g., disabling cookies), encrypting information, storing information in secure locations, using computer software to protect privacy (e.g., anti-spyware, anti-virus scanner, and firewalls), avoiding methods to collect or store the private information, concealing the private information from third parties, refusing to disseminate or disclose the private information to third parties, etc.

Private information of users includes valuable information that can be used without jeopardizing privacy concerns of users. For example, one embodiment obtains private information of a user and determines a product that the user desires to purchase based on this private information. This private information can be obtained from the user (such as the user confiding information to his intelligent personal assistant) or collected through observation of the user (such as extracting information about the user through observations of what material the user reads). This information is analyzed to determine a product that the user desires. An action is then taken with regard to the product, such as selling an identity of this product to an advertiser, disclosing an identity of this product to a social network, purchasing the product for the user, or taking another action. These actions are taken without disclosing the private information to a third party, such as the advertiser, the social network, etc.

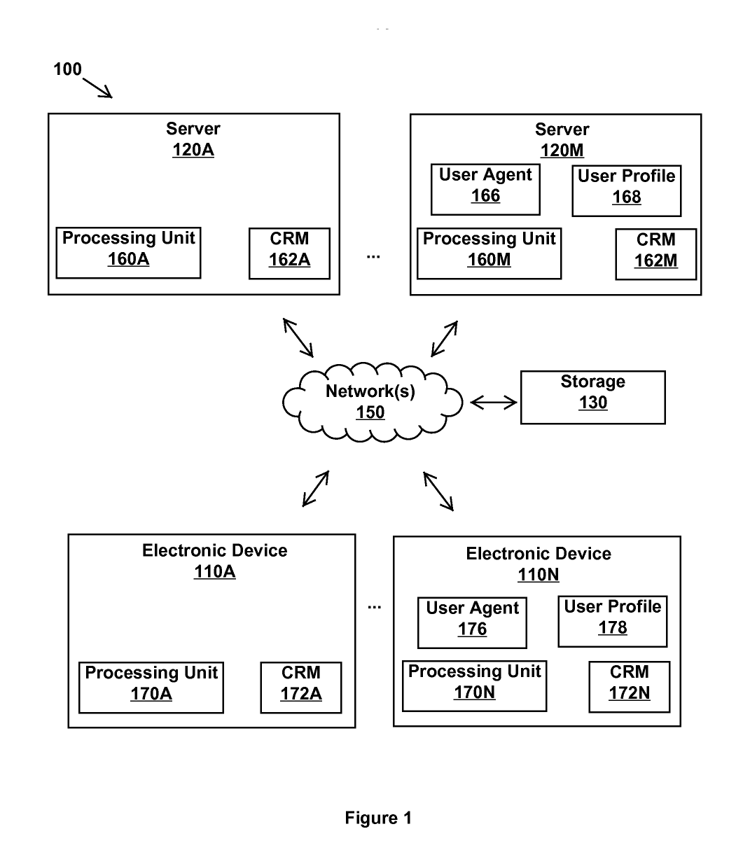

FIG. 1 is a computer system 100 in accordance with an example embodiment. The computer system includes a plurality of electronic devices 110A to 110N, a plurality of servers 120A to 120M, and storage 130 in communication with each other through one or more networks 150. The electronic devices, servers, and storage communicate through the networks to execute blocks and methods discussed herein. Blocks and methods discussed herein are executed with the computer system or one or more of the electronic devices, servers, and/or components therein.

The servers 120A to 120M include a processor unit with one or more processors and computer readable medium (CRM), such as random access memory and/or read only memory. Server 120A includes processor unit 160A and CRM 162A, and server 120M includes processor unit 160M and CRM 162M. The processing unit communicates with the CRM to execute operations and tasks that implement or assist in implementing example embodiments. One or more of the servers can also include a user agent and user profile, such server 120M including user agent 166 and user profile 168.

The electronic devices 110A to 110N include a processor unit with one or more processors and computer readable medium (CRM), such as random access memory and/or read only memory. Electronic device 110A includes processor unit 170A and CRM 172A, and electronic device 110N includes processor unit 170N and CRM 172N. The processing unit communicates with the CRM to execute operations and tasks that implement or assist in implementing example embodiments. One or more of the electronic devices can also include a user agent and a user profile, such as electronic device 110A including user agent 176 and user profile 178.

By way of example, the electronic devices 110A to 110N include, but are not limited to, handheld portable electronic devices (HPEDs), portable electronic devices, computing devices, electronic devices with cellular or mobile phone capabilities, digital cameras, desktop computers, servers, portable computers (such as tablet and notebook computers), handheld audio playing devices (example, handheld devices for downloading and playing music and videos), personal digital assistants (PDAs), combinations of these devices, and other portable and non-portable electronic devices and systems.

By way of example, the networks 150 can include one or more of the internet, an intranet, an extranet, a cellular network, a local area network (LAN), a home area network (HAN), metropolitan area network (MAN), a wide area network (WAN), public and private networks, etc.

By way of example, the storage 130 can include various types of storage that include, but are not limited to magnetic storage and optical storage, such as hard disks, magnetic tape, disk cartridges, universal serial bus (USB) flash memory, compact disk read-only memory (CD-ROM), digital video disk read-only memory (DVD-ROM), CD-recordable memory, CD-rewritable memory, photoCD, and web-based storage. Storage can include storage pools that are hosted by third parties, such as an operator of a data center. The electronic devices and/or servers can use the storage to store files, software applications, data objects, etc. Storage can be accessed through a web service application programming interface, a web-based user interface, or other mechanisms.

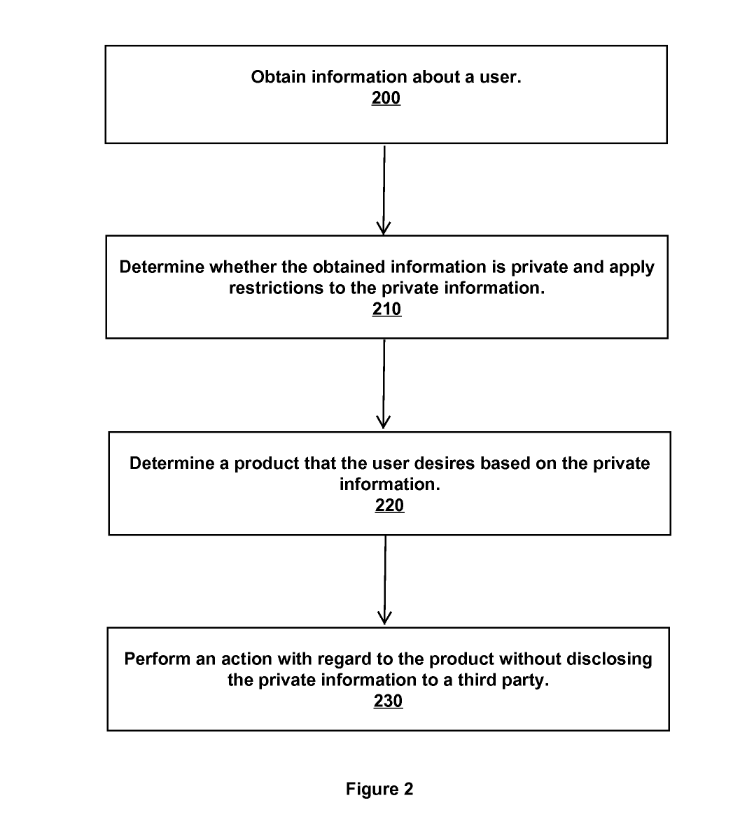

FIG. 2 is a method to determine a product that a user desires based on information obtained about the user. Once the product is determined, various actions can be taken with respect to the user and/or the product.

Block 200 states obtain information about a user. For example, the information about and/or from the user is collected, received, gathered, obtained, and/or retrieved. This information includes one or more of public information, private information, semi-private (information having some degree of privacy but not fully private), and semi-public (available to a portion, but not all, of the public).

Information can be collected for and/or retrieved from a user profile. One or more electronic devices monitor and collect data with respect to the user and/or electronic devices, such as electronic devices that the user interacts with and/or owns. By way of example, this data includes user behavior on an electronic device, installed client hardware, installed client software, locally stored client files, information obtained or generated from a user's interaction with a network (such as web pages on the internet), email, peripheral devices, servers, other electronic devices, programs that are executing, etc. The electronic devices collect user behavior on or with respect to an electronic device (such as the user's computer), information about the user, information about the user's computer, and/or information about the computer's and/or user's interaction with the network.

By way of example, a user agent and/or user profile builder monitors user activities and collects information used to create a user profile, and this user profile includes private information. The profile builder monitors the user's interactions with one or more electronic devices, the user's interactions with other software applications executing on electronic devices, activities performed by the user on external or peripheral electronic devices, etc. The profile builder collects both content information and context information for the monitored user activities and then stores this information. By way of further illustration, the content information includes contents of web pages accessed by the user, graphical information, audio/video information, uniform resource locators (URLs) visited, searches or queries performed by the user, items purchased over the internet, advertisements viewed or clicked, information on commercial or financial transactions, videos watched, music played, interactions between the user and a user interface of an electronic device, commands (such as voice and typed commands), hyperlinks clicked or selected, etc.

The user profile builder also gathers and stores information related to the context in which the user performed activities associated with an electronic device. By way of example, such context information includes, but is not limited to, an order in which the user accessed web pages (user's browser navigation), a frequency or number of times a user navigated to a web location, information regarding the user's response to interactive advertisements and solicitations, information about a length of time spent by the user on the web pages, information on the time when the user accessed the web pages, etc.

As previously stated, the user profile builder also collects content and context information associated with the user interactions with various different applications executing on one or more electronic devices. For example, the user profile builder monitors and gathers data on the user's interactions with a web browser, an electronic mail (email) application, a word processor application, a spreadsheet application, a database application, a cloud software application, and/or any other software application executing on an electronic device.

By way of illustration, the user profile builder collects content information for emails that include one or more of the recipient information, sender information, email subject title information, and the information related to the contents of the email including attachments. Context information for an email application may include the time when the user receives emails, time when the user sends emails, subject matter of the emails, frequency of the emails, recipients, etc.

Consider an example in which a user uses a natural language user interface to speak to a user agent that executes on an HPED of the user. The user speaks to the user agent and communicates private information about the user to the user agent. The user trusts that the user agent will store and maintain the private information in accordance with the restrictions and/or requests of the user. For instance, if the user discloses private information to the user agent and requests that this information not be revealed to any third parties, then the user agent will securely store this private information in accordance with the instructions of the user. A third party would not then have access to this information.

Consider an example in which a user authorizes a software program to gather private information about the user and then store and maintain this information in confidence and not disclose the information to any third party or entity. Since the user trusts the user agent to maintain the secrecy of the information and store the information in a secure and encrypted manner, the user is willing to allow the user agent to have access to private information of the user. For example, the user agent is authorized to listen to private telephone conversations between the user and third parties and extract private information of the user from these conversations (such as private information included in statements from the user to the third party). As another example, the user agent is authorized to read emails and text based messages written by the user and then extract private information from these messages. As another example, the user agent is authorized to override and/or disregard certain privacy settings established by the user and extract information as if the privacy settings were not set. For instance, the user sets privacy settings that deny access to and information obtained from a camera and microphone on an HPED. These privacy settings, however, do not apply to the user agent. As another example, the user agent is authorized to extract keywords and private information from voice memorandums that the user speaks into a recording device, such as an HPED. As yet another example, the user agent is authorized to retrieve private information from a personal electronic calendar or personal organizer software where the user stores personal information, such as personal notes, a To-Do list, and event schedules. As yet another example, the user agent is authorized to read and extract private information from personal writings of the user, such as electronic scratch pads, WORD documents, spreadsheets, presentations, and other documents that the user authors or reads. As yet another example, the user agent is authorized to track a location of the user and/or HPED of the user (such as using Global Positioning System, GPS) and extract private information from the user's position. As yet another example, the user agent is authorized to review purchases of the user (such as online and/or credit card purchases) and extract private information from such purchases. As yet another example, the user agent is authorized to review medical records of the user. As yet another example, the user agent is authorized to analyze and use any information collected by and/or stored in a user profile of the user.

Block 210 states determine whether the obtained information is private and apply restrictions to the private information. A determination is made as to whether the obtained information or portions of this information are private. For instance, the information is compared with the definitions and/or designations discussed herein to determine if the information is private and to determine what restrictions apply to the private information. For example, the private information is restricted or prohibited from being disclosed to any third party except the user and the user agent (or intelligent personal assistant of the user).

Private information is defined in order to determine what information is private and what restrictions are placed on this private information. For example, the user and/or owner of the information can specify which information is private and what restrictions occur with the private information. For instance, a user can designate with an electronic device one or more the types of information, such as private, public, semi-private, and/or semi-public. A default position can also determine whether information is private. For instance, privacy settings are set to a default position in which certain information is labeled and treated as being private to a user. A state or federal law can also determine whether information is public or private. For instance, it may be illegal to record participants in a private telephone conversation. A policy can also make information private or not. For instance, a company implements a policy that the content of emails transmitted in a workplace of the company are not private. For instance, private information can be labeled as being private if the information meets a definition.

A user, electronic device, software program, and/or third party can determine which types of information are private, such as what types of personal information are private. By way of example, these types of information include, but are not limited to, one or more of a demographic information about the user, communications (such as spoken and/or written) that the user has with third parties and/or electronic devices, information collected and/or stored in a user profile, user interface (UI) actions between the user and an electronic device, purchasing history, and data generated from the user being on the Internet or a network (such as information in cookies, websites visited, length of time at websites, searches performed, icons and/or links activated, user clicks, information viewed and/or ignored, etc.).

Private information can include various restrictions. These restrictions include, but are not limited to, determining whether and how the information is encrypted, where information is stored, retention policies for the information (such as whether information is stored or deleted and how long information is stored), access privileges for the information (such as who has a right to receive, read, edit, write, and/or copy the information), who has right to sell the information, dissemination and/or transmission policies for the information, what authorizations an electronic device, software program, and/or user agent has with respect to the information, etc.

Consider an example in which a user designates which information the user desires to be private and which information the user desires to be public and accessible to third parties. The user decides that all written and spoken conversations on an HPED are private and restricted from being accessible to any third party. As such, these conversations are available to only the user and a trusted user agent of the user. By way of example, during a telephone conversation between the user and his mother on the HPED, the user agent monitors the conversation and extracts keywords that are spoken by the user. These keywords enable the user agent to determine content in the conversation with regard to the user (content and/or conversation from the mother could be ignored if the user agent did not have authorization from the mother). Depending on the details of the authorization, the user agent could store one or more of a recording of the conversation or portions of the conversation, keywords extracted from the conversation, a summary of the conversation, specific or selected portions of the conversation, ideas extracted from the conversation, products mentioned in the conversation and words occurring before and after the products (i.e., words in proximity to the product word), etc. For instance, during the conversation, the user makes the following statement: “Well, I'm not sure, but I might go to Canada for a fishing trip again this summer if I can get time from work.” From this conversation, the user agent stores a note that the user has an interest to go to Canada for a fishing trip this summer.

Block 220 states determine a product that the user desires based on the obtained information. By way of example, analysis of the private information alone or coupled with non-private information enables a determination to be made of products that the user expressed an interest in purchasing, might intend to purchase, and/or would be interested in receiving at a time in the future. For example, this analysis enables a user agent (or intelligent personal assistant) to predict a product that the user desires to purchase at a point in time in the future.

Private information is examined to determine one or more products that the user may desire and/or may intend to purchase at a current time or at a time in the future. An analysis of one or more pieces of this private information occurs in order to make an intelligent prediction of products that the user desires to purchase at a current or future time. For example, a person, an electronic device, and/or a software program derives the product from an analysis of the private information about the user.

The determination that a user desires a product can be a prediction, an inference, a conclusion, a probability, a statistical likelihood, an educated guess, or technique that employs at least one of statistics, probability, and mathematics. For instance, a user desires a product when a probability or likelihood is more likely than not, greater than fifty percent, has a reasonable probability, exists by a preponderance of facts, meets a probability threshold (such as being 51%, 60%, 70%, 80%, 90%, 95% or higher), or falls within a probability range (such as being 51%-59%, 60%-69%, 70%-79%, 80%-89%, or 90%-99%). Furthermore, actions taken on the product (such as actions discussed in blocks and methods herein) can be based on such likelihoods.

As one example, the determination of the product can occur from an analysis of keywords extracted from private information entered into a handheld portable electronic device (HPED). For instance, these keywords are obtained from a user interface (UI) event with the HPED, such as user-generated information in a form of a text, an email, notes to a notepad, an entry in a calendar, a voicemail, and/or a voice exchange with another person. For instance, a user may state in an email or text certain keywords or phrases that indicate the user desires, needs, wants, and/or intends to purchase a product (such as “I want . . . ” or “I would like to have . . . ” or “I need . . . ” or “For my birthday . . . ” or “I saw a really nice . . . ” etc). As another example, this determination can include information extracted from a personal electronic device owned by the user. For instance, software and/or hardware on a tablet or personal computer of the user can be out-of-date or new software available, such as new software games or other software the user is interested in purchasing. For instance, the user may be interested in purchasing a new laptop computer, a new smart phone, or a new tablet computer. As yet another example, this determination can include private information extracted from a previous purchase of the user. For instance, if the user purchases a vehicle (such as a motorcycle, a car, a boat, etc.), the user may be interested in also purchasing an ancillary product for the vehicle. Alternatively, if the user purchases product X, then the user may also be interested in product Y since other customers that purchased product X also purchased product Y, and the user expresses an interest in product Y. As yet another example, this determination can include private information based on a current, previous, or future physical geographical location of the user. For instance, if the user plans a camping trip to a national forest, the user may be interested in purchasing camping and/or sporting gear. Alternatively, the user may have visited a specific type of store, such as one specializing in particular product. As yet a further example, this determination can also include private information from the user to the user agent and/or an electronic device. For instance, the user communicates with the user agent and expressly states what products the user would like to have (such as the user stating: “In the future, I would like to purchase upgraded editing software for my notebook”). As yet another example, this determination includes private information of the user's prior interest or activity in certain sports, travel destinations, clothes or objects previously purchased, or entertainment preferences. As yet another example, this determination is based on an age of goods or objects that the user owns or previously purchased, such as owning an electronic device that is outdated.

In an example embodiment, third parties are unable to determine the product per block 220 since these third parties neither know nor have access to the private information. Furthermore, this private information may not be otherwise obtainable from another source.

Consider an example in which a user drives alone in his car and listens to the radio. The user hears an advertisement for a new smartphone by ABC company and speaks to his user agent that executes on his HPED as follows: “Wow, I just heard an ad for ABC's new smartphone. Sounds like it has a lot of interesting features.” The user agent extracts from these statements that the user has an interest in the new smartphone by ABC Company. This information, which originated from a private conversation between the user and the user agent, forms private information for the user.

Consider an example in which a user agent collects private information about the user and predicts that the user would like purchase a music album from band XYZ. This prediction is based on one or more pieces of private information to which the user and user agent were privileged. For instance, the user asks the user agent to play some music for the user. Based on previous likes and dislikes of the user, the user agent selects songs from band XYZ that the user has not heard before. While listening to one of these songs, the user speaks to the user agent as follows: “Nice music selection. I really like the songs.”

In the examples above regarding the new smartphone by ABC Company and the music by band XYZ, no one else or nothing else, besides the user and the user agent, know this private information (i.e., that the user is interested in ABC's new smartphone or likes new songs by band XYZ). Further, this information is not otherwise attainable since the information originated from a private conversation between the user and his user agent. Furthermore, this information is not attainable from another source or even from the user agent since the information is encrypted and stored in a secure location. Further yet, the user agent is programmed to maintain this information secure and private, and the information is unattainable to third parties aside from the user and the user agent.

Block 230 states perform an action with regard to the product without disclosing the private information to a third party. Alternatively, one or more portions of the private information are disclosed to third parties in order to perform the action. Some examples of these actions are include, but are not limited to, disclose the product to the user, disclose the product to a third party, sell an identification of the product and/or the user to a third party, buy the product for the user, provide the product to a social network to which the user is a member, filter and/or prioritize advertisements or other information for the user, request and/or obtain advertisements, and/or perform an action per one or more blocks discussed in a method herein.

Consider an example in which a user goes into a retail store and purchases a tablet computer with cash. The user did not mention to another person that he would make this purchase. People who know about the purchase include the user, two employees at the retail store, and another customer in the store. As such, information of the user purchasing the tablet computer is limited to a few people. Furthermore, these people may not even know an identity of the user. Advertisers or other third parties would not be able to contact the user or send advertisements to the user based on the purchase of this product since they are not aware of the purchase. This information is private. Shortly after purchasing the tablet computer, the user verbally instructs his user agent that he just bought the tablet computer (such as the user saying: “I just bought a new tablet computer. Can't wait to use it tonight.”). From this information, the user agent determines that the user bought a tablet computer. The user agent can take action on this information that originated in a conversation with the user, such as requesting an advertiser to send the user an advertisement about software games that can be purchased for the tablet computer. But for the actions of the user agent, the advertiser would not have been able to send this advertisement since the advertiser was unaware that the user purchased a tablet computer. The user agent could also take additional actions as discussed in method blocks and examples herein.

Consider an example in which each weekend a user goes out to eat dinner at one of several Italian restaurants on the East side of his city. Several other Italian restaurants exist on the West side of the city, but the user is not aware of these restaurants. Further, these restaurants are not privy to the private eating habits of the user and are unaware that the user frequently eats at Italian restaurants on the East side. As such, these Italian restaurants on the West side are not able to advertise to the user since they are unaware of his identity and his personal eating habits. A user agent for the user is aware of the user's identity and his personal eating habits. The user agent also has a reasonable belief that the user would be interested in eating at the Italian restaurants on the West side. Without knowledge or instructions from the user, the user agent contacts the Italian restaurants on the West side and requests advertisements. In the process of requesting these advertisements, the user agent neither discloses an identity of the user nor his personal eating habits to the West side Italian restaurants. Instead, the user agent requests advertisements, and then directs these advertisements to play on an HPED of the user. Thus, the user agent was able to take action (i.e., request and retrieve advertisements) based on private information of a user without disclosing the private information to a third party.

In the example of the Italian restaurants, the user agent was able to take an action based on the private information of the user without disclosing this private information to third parties. Before the user agent took action on this information, a number of people did know that the user ate dinner at Italian restaurants on the East side each weekend. For instance, friends or relatives of the user might know this information about the user. Additionally, employees at these restaurants would know this information. After the user agent took action on the private information, however, the number of people who knew the private information did not change. In other words, a number of people that knew before the user agent contacted the West side restaurants for advertisements was equal to a number of people that knew after the user agent contacted the restaurants. Thus, the user agent took action on the private information without disclosing the information to third parties and without breaching a trust relationship between the user and the user agent.

Consider an example in which advertisers sends various advertisements for display on an HPED of a user. These advertisements are directed to automobiles and consumer electronic devices. An intelligent personal assistant (IPA) previously analyzed private information of the user and determined various products about which that the user is interested in receiving more information. The IPA compares a list of these products with subject matters of the advertisements and performs the following actions: The advertisements directed to automobiles are filtered and prevented from being displayed to the user since automobiles are not on the product list. The advertisements directed to consumer electronic devices are ordered in a hierarchy that is based on a level of interest of the user. For instance, the IPA determines from the private information that the user has a first highest likelihood of desiring information about tablet computers, a second highest likelihood of desiring information about printers, and a third highest likelihood of desiring information about televisions. Based on these likelihoods, the IPA assigns a priority to the advertisements of the consumer electronic devices. For instance, advertisements directed to selling tablet computers or HPEDs are prioritized and shown first to the user; advertisements directed to selling printers are prioritized and shown second to the user; and advertisements directed to selling televisions are prioritized and shown third to the user.

Consider an example in which the user enjoys and plays a game AA on a tablet computer. An act of the user playing this game and an amount of time spent playing this game are private information. This private information is not known to any organization or any person other than the user. Based on this private information, the user agent for the user predicts that the user would like to play on the tablet computer game BB, which is a different game. The user agent then contacts the manufacturer and/or an online retailer of game BB and requests additional information about game BB. For instance, this additional information could be an advertisement, a video showing the game, price information, literature about the game BB, etc. The manufacturer and/or online retailer are not provided any of the private information. Alternatively, instead of requesting the information from the manufacturer and/or online retailer, the user agent could locate and retrieve this information on the Internet and provide the information to the user.

Consider an example in which an intelligent personal assistant of a user obtains private information about a user. The IPA determines that this private information is restricted from being disclosed to and/or known by any party except the user and the IPA. The IPA analyzes the private information in order to predict a product that the user desires to purchase. An identity of the user and an identity of the product are provided to another user agent of another user without disclosing any of the private information to a third party including the other user agent and the other user. The other user agent purchases the product as a gift for the user based on an authorization to purchase gifts from the other user. The other user agent has the purchased gift delivered to the user.

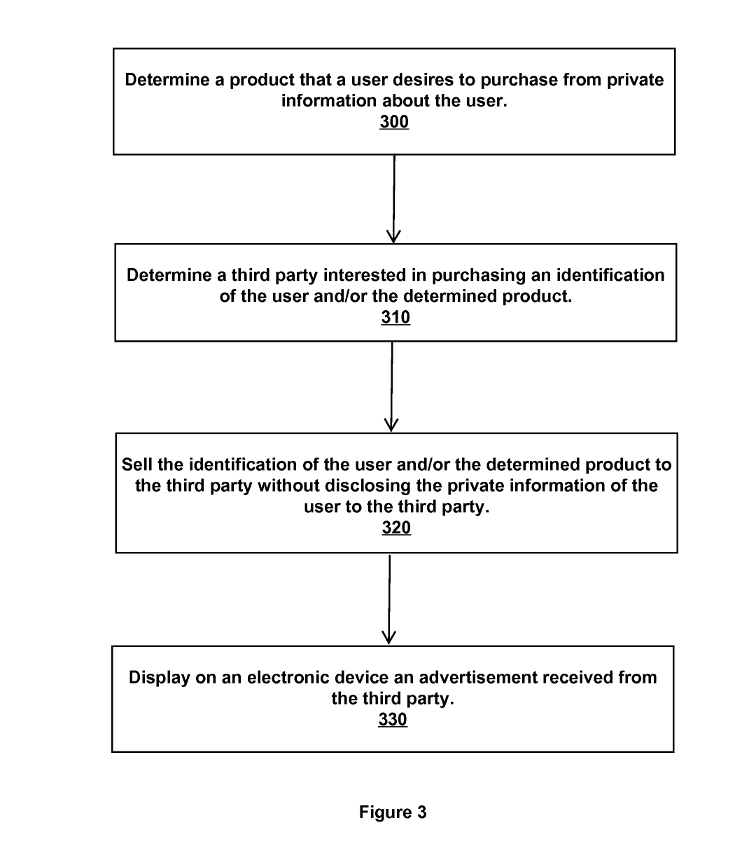

FIG. 3 is a method to sell a product determined from private information of a user.

Block 300 states determine a product that a user desires to purchase from private information about the user. For example, the user provides the information (including private and/or non-private information) and/or the product to a user agent of the user, a software program, and/or an electronic device. As another example, the product is derived from an analysis of a user profile of the user and/or determined in accordance with a block discussed in connection with FIG. 2.

Block 310 states determine a third party interested in purchasing an identification of the user and/or the determined product.

The user is a potential or likely purchaser of the derived product. As such, third parties that sell, supply, investigate, distribute, market, and/or provide this product are interested in purchasing the identification of the user and the derived product. By way of example, these third parties include, but are not limited to, advertisers, retailers of the product, manufacturers and/or distributers of the product, credit agencies, commercial data brokers, insurance and related companies, companies that store data (such as database companies), health care companies, government agencies, marketing and/or advertising companies, and businesses.

An identification of a user includes, but is not limited to, one or more of first and/or last name, an email address, an Internet Protocol (IP) address, date of birth, national identification number, driver's license number, national identification number, facial image, digital identity, age, gender, race, birthplace, genetic information, residence address, business address, social network address (such as information to identify the user on TWITTER, FACEBOOK, GOOGLE PLUS, etc.), and other information that can identify and/or locate the user.

Consider an example in which a user instructs his user agent that he is interested in purchasing a television. In addition to retrieving information about televisions for the user, the user agent searches the Internet and locates online retailers that sell televisions. The user agent then messages these online retailers and asks them if they are interested in purchasing an identification of a user that desires to buy a television. If the retailers are interested, then the user agent provides a contact for the user, such as providing a residential address, a business address, an email address, a webpage of the user, a social network name of the user, etc. Alternatively, the user agent does not provide an identity of the user to the retailers. Instead, the retailers provide the information to the user agent or provide the user agent with a location where to retrieve the information, and the user agent provides the information to the user. In this manner, an identity of the user is maintained private and/or confidential.

Consider an example in which a user agent analyzes private information of the user and determines that the user is planning to purchase a kitchen appliance. The user agent uses the Internet to contact an advertising broker or an advertising agency with clients that manufacture and/or sell kitchen appliances. These brokers and/or agencies pay a predetermined fee for finding users that will purchase a product of their client.

Block 320 states sell the identification of the user and/or the determined product to the third party without disclosing the private information of the user to the third party. Alternatively, one or more portions of the private information are disclosed to third parties in order to perform the action.

Consider an example in which a user agent determines, from private information of a user, a product that the user desires to purchase in the future. The user agent communicates via the Internet with an advertising agency having a client that sells the product. The user agent offers to provide an identity of the user and the product in exchange for compensation from the agency (compensation such as money, coupons, product discount, etc.). The advertising agency accepts this offer and provides the compensation to the user and/or user agent. In further exchange for providing the compensation, the user agent agrees to display and the user agrees to actually view an advertisement for the product on an electronic device of the user. Thereafter, the advertiser sends the user agent a video advertisement for the product. This video advertisement plays on an HPED of the user while the user views the video advertisement.

As one example of an action, the user agent sells an identification of the product to a third party without disclosing the private information to the third party. The third party receives an identification of the product but does not receive and/or know an identification of the user and the private information from which the product was derived.

Consider the example above in which the user expressed a like in music by XYZ band. From this private information, the user agent surmised or predicted that the user would like the album of XYZ that includes the songs played for the user. The user agent contacts an advertiser and/or retail music seller that sells the album of XYZ and sells to them the information that the user might be interested in purchasing the album of XYZ. While providing this information, the user agent maintains the original information private. In other words, the user agent does not disclose to the advertiser or the retail music seller any information regarding the private information and/or circumstances regarding the private information (i.e., that the user agent played songs from band XYZ for the user and that the user then commented “Nice music selection. I really like the songs.”). The sale of the information occurred while maintaining the privacy of the private information. Instead, the user agent analyzed the private information in order to predict that the user would like to have or would be interested in hearing more information about the album of band XYZ.

In return for receiving the information about the user (i.e., the user might be interested in purchasing the album of XYZ band), the advertiser pays the user agent. For example, the advertiser pays a small monetary fee into an account that the user owns. The advertiser then provides the user agent and/or user with an advertisement for the album of XYZ band. The advertisement is then displayed and played to the user on an electronic device.

The advertiser is willing to pay a fee and/or provide other types of compensation for the information from the user agent since the user is more likely to actually purchase the album of XYZ band when compared with a random user and/or a user that did not express an interest in purchasing the album.

Block 330 states display on an electronic device an advertisement for the product received from the third party. For example, an advertisement is displayed on an electronic device (such as an HPED) of a user in exchange for or consideration for the user receiving compensation from an advertiser.

Consider an example in which private information of a user indicates that the user is considering purchasing a condominium in the next three to six months. An intelligent personal assistant (IPA) of the user contacts a developer that owns rights to sell condominiums. This developer pays the IPA a fee in exchange for the IPA showing the user a video advertisement about the condominiums that the developer sells. The IPA displays the video advertisement to the user and determines that the user indeed watched the video (e.g., the video advertisement remained a focused window, the user's eyes were tracked to determined that the user actually viewed the video, a head and eyes of the user were positioned in front of and toward the display while the video played, the user performed an action after the video played to acknowledge watching the video, etc.).

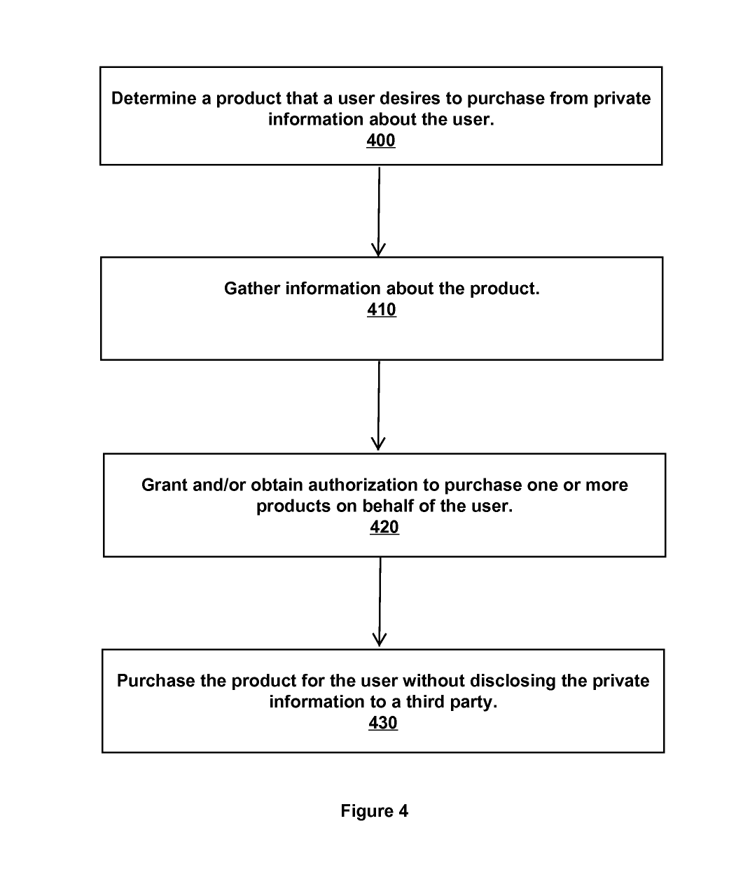

FIG. 4 is a method to purchase a product determined from information about a user.

Block 400 states determine a product that a user desires to purchase from private information about the user. For example, the user provides the information (including private and/or non-private information) and/or the product to a user agent of the user, a software program, and/or an electronic device. As another example, the product is derived from an analysis of a user profile of the user and/or determined in accordance with a block discussed in connection with FIG. 2.

Block 410 states gather information about the product.

By way of example, an electronic device and/or user agent of the user gathers information from the Internet about the products that the user expressed an interest in purchasing, might intent to purchase, and/or would be interested in receiving information. This information about the products includes, but is not limited to, advertisements for the products, a price of the products, a geographical location of the products, availability of colors/sizes/shapes/etc. of the products, whether the products are in stock and/or available for immediate shipping or purchasing, promotions and discounts of the products, shipping times and expenses of the products, detailed information of the products (such as technical specifications, warranties, product descriptions, etc.), video (including pictures) of the products, audio of the products, comments from other users of the products, warranties offered for the products, and written reviews of the products.

Block 420 states grant and/or obtain authorization to purchase one or more products on behalf of the user. For example, a user grants his user agent or his intelligent personal assistant authority to purchase products on behalf of the user using an e-commerce business (such as PAYPAL) or a credit card of the user. This authorization can be a general permission (such as authorization to make various purchases during the next two years on behalf of the user at the discretion of the user agent) or can be more to a specific transaction (such as a single or one-time authorization to buy a tablet computer for the user).

Block 430 states purchase the product for the user without disclosing the private information to a third party. Alternatively, one or more portions of the private information are disclosed to third parties in order to perform the action.

The product can be purchased with or without knowledge and/or instruction from the user. For example, a user agent of the user purchases the product for the user without knowledge of the user that the user agent purchases the product for the user and without disclosing any of the private information to a third party including an entity from whom the product is purchased.

Consider an example in which a user grants a user agent with authorization to purchase, on behalf of the user, games for the user's tablet computer. This authorization states that the user agent is authorized for a one-year period to purchase the games on behalf of the user, charge the games to the user's credit card, and have a cumulative price limit during the year of $500. The user agent can purchase the games without express knowledge and/or specific instructions from the user since the user agent has the general authorization to act on behalf of the user and make purchases. Subsequently, during the year, the user agent determines a game that the user agent believes the user would enjoy and purchases this game for the user. The user is notified of the purchase after the game is purchased and sent to the user.

Consider an example in which the user expresses an interest in features of ABC's new smartphone. Based on this information, the user agent decides to purchase ABC's new smartphone for the user as a surprise gift for the user. The user is not aware that the user agent is making this purchase for the user. The user agent purchases the smartphone as a surprise gift for the user and then has the gift delivered to the user.

Consider an example in which each year the user agent purchases a gift for the birthday of the user. The user is not aware which gift the user agent will purchase and may think as follows: “I wonder what gift my user agent will get me for my birthday this year.” The user may provide the user agent will authorization to make purchases (such as providing the user agent with authorization to charge a credit card) and may provide restrictions and/or guidelines regarding such purchases (such as providing limits and/or information on how much money the user agent is authorized to spend, how often the user agent can purchase a product, when the user agent can purchase a product, what categories of products the user desires, what source of monetary funds the user agent is authorized to used in order to purchase the product, what occasions and/or events the user agent is authorized to make purchases, and for whom the user agent is authorized to buy products).

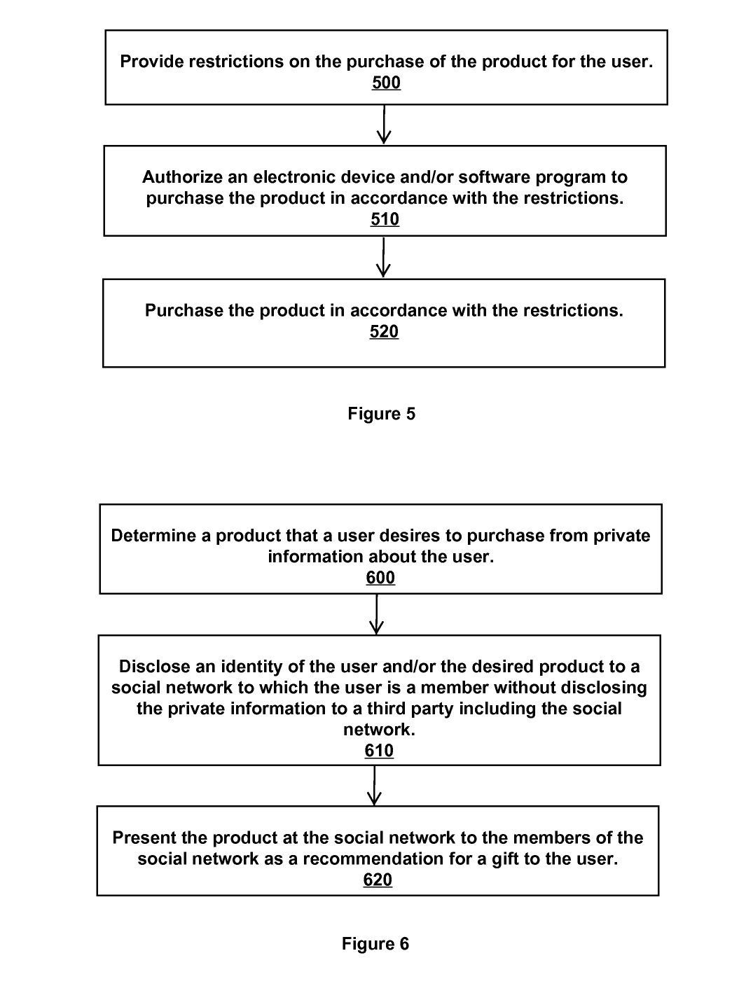

FIG. 5 is a method to authorize an electronic device and/or software program to purchase a product for a user.

Block 500 states provide restrictions on the purchase of the product for the user. The restrictions provide guidelines, boundaries, limits, terms, conditions, instructions, and/or definitions regarding the purchase of the product.

Block 510 states authorize an electronic device and/or software program to purchase the product in accordance with the restrictions. The electronic device and/or software program can legally act on behalf of the user and conduct transactions in accordance with the restrictions and/or instructions from the user. Examples of authorization are also discussed in connection with block 420 and FIG. 4.

Block 520 states purchase the product in accordance with the restrictions.

Consider an example in which a user desires his user agent to purchase a birthday gift each year for his nephew. The user provides the user agent with the following restrictions and/or instructions to assist the user agent in purchasing the birthday gift: (1) the nephew is a boy eleven years old, (2) the birthday is the sixth of May, (3) the nephew prefers electronic devices and sports equipment, (4) buy the product online, (5) ship the product to a home address of the nephew with the product arriving within one week before the birthday, and (6) the purchase price of the product should not exceed $100. Further, the user authorizes the user agent to purchase a birthday gift for the nephew every year using a credit card of the user. After the user agent purchases the birthday gift for the nephew, the user agent is instructed to email a receipt of the purchase to the user. The user does not know which gift the user agent purchased until after the purchase is made. Alternatively, the user agent informs the user before making the purchase.

Consider an example in which a user desires to receive a surprise Christmas gift each year from his user agent. The user provides the user agent with the following restrictions and/or instructions to assist the user agent in purchasing the Christmas gift: (1) the agent should extract private information from a user profile of the user and predict a gift that the user agent determines that the user would like to receive, (2) maintain an identity of the gift a secret from the user and all other persons, (3) purchase the gift from any online retailer, (4) have the gift gift-wrapped and delivered to the user's home address before Christmas day, and (5) spend between $100-$300 on the gift.

Consider an example in which a user commands an intelligent personal assistant (IPA) that executes on his HPED to purchase a gift for his friend. The user provides the IPA with the following restrictions and/or instructions to assist in purchasing the gift: (1) the name of the friend is Jane Smith, (2) the IPA should contact the IPA of Jane Smith and request a recommendation from her IPA for a gift, (3) the acts of purchasing the gift and an identity of the gift should be kept secret from Jane Smith but can be disclosed to her IPA, (4) the gift should be shipped to a business address of Jane Smith using priority mail or overnight delivery, and (5) the purchase price of the gift should not exceed $50.

Consider an example in which a friend of the user desires to purchase a gift for the user. The friend instructs his user agent to contact the user agent of the user and ask for a recommendation on a gift that the user would desire to receive. The user agent of the user instructs the user agent of the friend that the user would be interested in receiving movie passes to a local cinema. This recommendation to buy movie passes is based on private information that was not disclosed to the user agent of the friend. For instance, a private calendar of the user (to which the user agent has access) indicates that the user historically went to the local cinema about one time per month. This private information was not disclosed to the user agent of the friend or the friend. Instead, this private information was analyzed to make a prediction that the user would desire movie passes to the local cinema, and this prediction was provided to the user agent of the friend. The user agent of the friend does not know how the user agent generated the recommendation of the product (i.e., the movie passes).

FIG. 6 is a method to disclose to a social network a product that a user desires.

Block 600 states determine a product that a user desires to purchase from private information about the user. For example, the user provides the information (including private and/or non-private information) and/or the product to a user agent of the user, a software program, and/or an electronic device. As another example, the product is derived from an analysis of a user profile of the user and/or determined in accordance with a block discussed in connection with FIG. 2.

Block 610 states disclose an identity of the user and/or the desired product to a social network to which the user is a member without disclosing the private information about the user to a third party including the social network. Alternatively, one or more portions of the private information are disclosed to third parties in order to perform the action. For example, the identity of the user and the product can be provided to and/or exchanged with the social network and members or friends of the user in the social network to which the user and members or friends belong without disclosing any of the private information to the social network, members, friends, or any third party.

By way of example, the identity of the desired product includes, but is not limited to, one or more of a name of the product, a description of the product, a cost of the product, a location where to purchase the product (such as a website, hyperlink, name of retail or online store, etc.), and particulars of the product with regard to the user (such as size, shape, color, make, model, etc.).

Block 620 states present the product at the social network to the members of the social network as a recommendation for a gift to the user. For example, members of the social network can search the name of the user to determine gifts that the user would desire to receive. Additionally, the gifts can be presented at a website of the social network, such as being presented at the user's social networking webpage. These gives are products received from the user, the user agent or intelligent personal assistant of the user, an electronic device, or a software program.

Consider an example in which a Global Positioning System (GPS) on an HPED of the user tracks locations of the user but maintains these locations as private information. The private GPS information indicates that the user has frequented an electronic retail store of Company MNO. This company sells consumer electronics online and in various retail stores throughout the world. Based on this private information, the HPED determines that the user would like to have a gift certificate to the retail and/or online store of Company MNO. The HPED provides this information to a social network to which the user is a member. Members of the social network and/or friends of the user can review, retrieve, and/or search this information to find gifts to purchase for the user.

This determination (i.e., that the user would like to have a gift certificate) does not reveal or disclose the private information (i.e., that the user frequented the retail store). Instead, this private information is used to make a prediction, infer a conclusion, or generate a determination that the user would like to have the gift certificate. An identity of the product and information about the product are disclosed to the social network without revealing the private information that was analyzed to derive the product. Thus, the private information is not revealed even though it is the source or origin of the determination of the product.

By way of example, the user is a member of a social network, such as FACEBOOK. The HPED of the user posts or provides the determination (i.e., that the user would like to have a gift certificate) to the social network. In turn, FACEBOOK provides this product (i.e., the gift certificate) to members as a recommendation for a gift for the user. A friend of the user (e.g., a person in FACEBOOK that the user accepted as a friend in the user's social network) queries the social network to determine a gift recommendation for the user. This query returns an answer that the user would be interested in receiving a gift certificate to Company MNO.

HPEDs and/or user agents of users of the social network can automatically provide the products to the social network. Other members and/or friends in the social network can search and discover these products. In this manner, the social network maintains gift recommendations for its members. These recommendations are based on private information of the members without disclosing the actual private information to the social network or its members.

In an example embodiment, the social network itself collects and analyzes private information about its users and then determines products and gift recommendations for them. For example, the social network monitors member activity within the social network, such as user interface events while the user is logged into the social network.

This embodiment of the social network collecting and analyzing private information, however, may have limitations with regard to what private information is available to determine products. These limitations apply to the social network but would not apply to a user agent of the user. As such, the user agent can have a broader ability to capture private information of the user. As an example of this limitation, users generate vast amounts of private information when they are not logged into the social network. For instance, users generate private information while they are not logged into the Internet (e.g., users may be speaking on a telephone, working on a spreadsheet on a computer not connected to a network, updating an electronic calendar that is an application not in communication with the social network, speaking with a user agent that is not affiliated with the social network, etc.). This private information would not be available to the social network but would be available to a user agent that executes on an HPED of the user. Additionally, even if the user is logged into the social network, the user can generate information that the social network cannot collect or access. For instance, the user may be using the Internet but navigating to network spaces not affiliated or associated with the social network. In this instance, the social network would not have collected the private information. The user agent, on the other hand, can collect this information since it has access to all user interface events that occur on the electronic device of the user. Further yet, the user agent can simultaneously execute on multiple electronic devices of the user regardless of whether these devices are connected to a network, such as the Internet. Thus, the user agent can continue to collect private information with or without the electronic device of the user having a network connection.

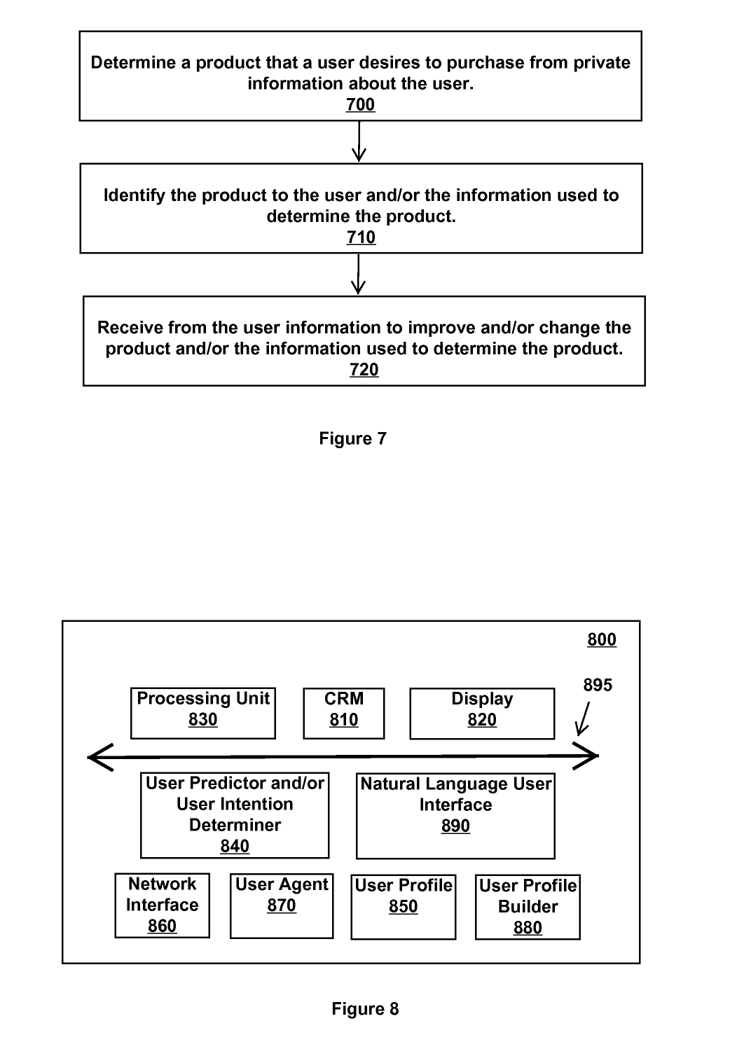

FIG. 7 is a method to interact with a user to improve determining a product that is based on private information about the user.

Block 700 states determine a product that a user desires to purchase from private information about the user. For example, the user provides the information (including private and/or non-private information) and/or the product to a user agent of the user, a software program, and/or an electronic device. As another example, the product is derived from an analysis of a user profile of the user and/or determined in accordance with a block discussed in connection with FIG. 2.

Block 710 states identify the product to the user and/or the information used to determine the product.

An identity of the product and/or the information used to determine the product is provided to the user. For example, the product and the information to determine the product are spoken and/or written to the user.

Consider an example in which a software program gathers information about a user and analyzes this information to determine products that the user wants or desires. This information includes private information of the user. When the software program determines a product, the software program places an identity of the product on a desktop of the user. For instance, thumbnail pictures of the products are placed in a folder located on the desktop of a user's HPED. When the user clicks or taps on one of the pictures, the user is navigated to a website where to buy the product. Alternatively, clicking or tapping on the pictures provides the user with more information about the product, such as providing a name of the product, a location and a price of the product, a hyperlink to a retailer that sells the product, an enlarged picture of the product, a date and time when the product was added to a product list of the user, a description of the product, and/or a list of the private information analyzed to determine the product.

Block 720 states receive from the user information to improve and/or change the product and/or the information used to determine the product. The user communicates information to change and/or improve the performance of determining products that the user desires.

Consider an example in which a mobile application executes on an HPED of a user. This mobile application analyzes private information of the user, determines products that the user would want, obtains a picture of these products from the Internet, and displays an icon on the desktop of the HPED. When a user activates the icon, the pictures of the products are displayed on the HPED. Thereafter, the user can select a picture to accept or delete it. Accepting a picture signifies that the user does indeed want this product. Deleting a picture signifies that the user does not want this product (e.g., the user drags the picture of the product to a trash). For instance, when the user right-clicks on the picture, the display presents actions to take with regard to the product, such as delete the product from the product list, approve the product in the product list, display more information about this product, navigate to a website that sells this product, and display the private information used to determine this product.

Consider an example in which a user agent of a user is a software application that is as an intelligent personal assistant for the user. This user communicates with the user agent with written text (such as typing text into an HPED) and/or with a natural language user interface. Using this natural language user interface, the user asks the user agent what products the user agent believes the user desires and what information the user agent used to make this determination. Consider the following hypothetical conversation in which a user (named John) talks with his user agent (named Paul) that executes on an HPED of the user:
John (user): “Paul, please tell me what products do you believe I desire to own based on an analysis of my private information?”
Paul (user agent): “John, I believe you desire to own the new smartphone made by SAMSUNG.”
John (user): “Paul, on what information do you base this belief?”
Paul (user agent): “John, I base this belief on the following information. Last week, in a telephone conversation with your mother, you mentioned that your current smartphone is not working well and that you may need a new one. Then, three days ago, you stopped in front of a SAMSUNG retail store and stayed for several minutes.”

In this hypothetical the user agent uses private information of the user to determine that the user would desire to have a smartphone. The telephone conversation was private between the user and his mother. Assuming neither John nor his mother discussed the conversation with a third party, then the contents of this conversation would not be known to anyone except the user, the user's mother, and the user agent. Further, the fact that the user stopped in front of the retail store may not be known to anyone or may be known to a small group of individuals (such as individuals that saw the user at the store). From the combination of these pieces of private information, the user agent is able to make an intelligent prediction of a product that the user would desire (i.e., John would desire the SAMSUNG smartphone or a new smartphone from another company).

Consider another example in which a user speaks with his user agent using a natural language user interface. The user asks the user agent what products the user agent recommends that the user would like to purchase and what basis the user agent has for the recommendations. The user agent responds that the user would like to purchase a pair of NIKE cross-training tennis shoes and a new FORD pickup truck. A recommendation to purchase the tennis shoes is based on a fact that the user historically buys a new pair of NIKE cross-training tennis shoes every 9 months and it has been 8 months since the last purchase. A recommendation to purchase the truck is based on a fact that the user emailed a picture of one such truck to a friend and wrote “nice truck” in the email. The user instructs the user agent that the user is indeed interested in buying tennis shoes, but not the brand NIKE, but the brand ADIDAS. The user also instructs the user agent that the user is not interested in buying a new automobile. In response to this communication, the user agent updates its product recommendation list and updates the private information.

Consider another example in which a user speaks with his user agent using a natural language user interface. While a user is alone driving in his car, the user notices a new shopping complex with many retail stores. The user speaks a command and instructs the user agent to make a note of the location of the shopping complex because it appears to have some great stores. Based on this private information, the user agent determines a product that the user would like to have (e.g., a gift certificate that is redeemable in retails stores at the shopping complex). Thereafter, the user agent provides this product to a social network to which the user is a member.

Thus, the user agent and user can communicate via a natural language communication user interface in which the user agent provides spoken words that identify plural products that the user agent believes the user desires to receive. These products are determined from an analysis or examination of private and/or non-private information of the user. The user, in turn, provides spoken words to the user agent in order to modify, clarify, affirm, accept, or reject products in the list of products provided by the user agent. For instance, the user instructs or commands the user agent to reject or delete some products in the list of products, accept or affirm some products in the list of products, and/or modify or change some products in the list of products.

The user can also provide the user agent with instructions on how to improve an analysis of the private information to more accurately determine products that the user desires. For example, the user asks for or is presented with a list of the private information that the user agent used to analyze and determine a product that the user might want. Some of this private information was extracted from a personal calendar of the user. In extracting and analyzing this private information, however, the user agent misinterpreted the information. The user provides the user agent with instructions on how the information was misinterpreted. As another example, the user agent determined a user wanted a product based on information extracted from an email that the user sent to his friend. The user agent, however, incorrectly interpreted content of the email, and the user provides the user agent with instructions on what mistakes were made in construing content in the email.

In an example embodiment, the user agent knows and/or has access to private information about the user from various private sources. The user can restrict and/or deny the user agent from having access to one or more of these sources. For example, assume the user agent has access to private information included in emails of the user, phone conversations of the user, voice messages of the user, calendar events of the user, voice memorandums of the user, text messages of the user, GPS locations of the user, UI events of the user, web browsing of the user, and conversations between the user and the user agent. The user instructs the user agent that the user agent no longer has access rights to phone conversations and emails since the user wants these sources to remain private to only the user and the third party with whom the user is interacting. As such, these information sources are removed from the list of sources to which the user agent has authorization to monitor for private information. The user can also add information sources, such as the user instructing the user agent to also monitor messages that the user sends to members of a social network to which the user is a member.

Private information includes information about the user that the user designates as being private and restricted from third parties (such as personal information including, but not limited to, name, birthday, telephone number, social security number, credit card number, health care records, criminal justice investigations and proceedings, financial information and financial transactions, biological traits, ethnicity, religious beliefs, and/or factual information that would negatively impact a user's personal life if it were to become public), information that is not known to one third party but known to other third parties (such as private information known only to the user and his doctor but not to third parties outside of the user and his doctor), information that is known to a limited number of people (such as private information known only to the user and the user's family but not to third parties outside of the user and the user's family), information that is not known to any third parties (such as information known only to the user). Private information also includes information that is individually identifiable (i.e., the identity of the individual is or may readily be ascertained).

When information is determined to be private, the information can be stored, transmitted, and/or shared while protecting and maintaining privacy of this information. Data security and information security utilize techniques, hardware, software, and human resources to address these issues.

FIG. 8 is an electronic device 800 in accordance with an example embodiment. The electronic device includes components of computer readable medium (CRM) or memory 810, a display 820, a processing unit 830, a user predictor and/or user intention determiner 840, a user profile 850, a network interface 860, a user agent 870, a user profile builder 880, a natural language user interface 890, and one or more buses or communication paths 895. FIG. 8 shows these components in a single electronic device. Alternatively, one or more of these components can be distributed or included in various electronic devices, such as some components being included in an HPED and/or a peer, some components being included in a server, some components being included in storage accessible over the Internet, components being in various different electronic devices that are spread across a network, etc.

The processor unit 830 includes a processor (such as a central processing unit, CPU, microprocessor, application-specific integrated circuit (ASIC), etc.) for controlling the overall operation of memory 810 (such as random access memory (RAM) for temporary data storage, read only memory (ROM) for permanent data storage, and firmware). The processing unit 830 communicates with memory 810 and performs operations and tasks that implement one or more blocks of the flow diagrams discussed herein. The memory 810, for example, stores applications, data, programs, algorithms (including software to implement or assist in implementing example embodiments) and other data.

The network interface 860 provides a mechanism for the electrical device 800 to communicate with other electrical devices, computers, users, or systems. For example, the network interface 860 enables the electrical device to transmit data through a wired or wireless connection to a network, such as the Internet and/or a cellular network.

Blocks and/or methods discussed herein can be executed and/or made by a user, a user agent of a user, a software application, an electronic device, a computer, a computer system, and/or an intelligent personal assistant. Furthermore, blocks and/or methods discussed herein can be performed without knowledge of the user and/or without instruction from the user. Consider an example in which a user is without knowledge of when an action occurs but has provided instruction for the action. Consider an example in which the user has knowledge of an action but did not instruct the action. Consider an example in which a user agent of a user performs an action without the user having knowledge of the action and without the user providing the user agent with specific instruction to perform the action.

Determinations by a software application, an electronic device, and/or the user agent can be modeled as a prediction that the user with take an action. For example, an analysis of historic events, personal information, geographic location, and/or the user profile provides a probability and/or likelihood that the user will take an action (such as determining whether information is private information, determining what product to obtain from private information, determining to which third party to sell and/or provide an identification of the user and/or an identification of the product, and determining how to execute blocks in methods discussed herein). By way of example, one or more predictive models are used to predict the probability that a user would take, determine, or desire the action. The predictive models can use one or more classifiers to determine this probability. Example models and/or classifiers include, but are not limited to, a Naive Bayes classifier (including classifiers that apply Bayes' theorem), k-nearest neighbor algorithm (k-NN, including classifying objects based on a closeness to training examples in feature space), statistics (including the collection, organization, and analysis of data), support vector machine (SVM, including supervised learning models that analyze data and recognize patterns in data), data mining (including discovery of patterns in datasets), artificial intelligence (including systems that use intelligent agents to perceive environments and take action based on the perceptions), machine learning (including systems that learn from data), pattern recognition (including classification, regression, sequence labeling, speech tagging, and parsing), knowledge discovery (including the creation and analysis of data from databases and unstructured data sources), logistic regression (including generation of predictions using continuous and/or discrete variables), group method of data handling (GMDH, including inductive algorithms that model multi-parameter data) and uplift modeling (including analyzing and modeling changes in probability due to an action).

As used herein, the term “information” includes communication and/or reception of knowledge and/or intelligence, and knowledge obtained from investigation, study, and/or instruction. Information also includes data, such as information in numerical form that can be digitally transmitted and/or processed. Thus, information includes raw data and unorganized facts that can be processed, and also includes processed, organized, and structured, such as data being processed and presented in a useful context.

As used herein, an “intelligent personal assistant” or an “IPA” is a software application that performs tasks or services for an individual user based on user input, location awareness, user interface events, and/or abilities to access private and non-private information. The IPA can be an intelligent software agent that performs tasks with minimum specific directions from users.

As used herein, “private information” includes information pertaining to a user's behavior, actions, and/or communication that occurs in a context in which an individual can reasonably expect privacy, information provided by an individual for a specific purpose and for which the individual can reasonably expect will not be made public (for example, an email between two friends or medical records), and/or information that is not known or intended to be known publicly. Private information can be known by a single person (such as a user knowing a secret about himself or herself), or it can be known to more than one person and still be private (such as personal information about a user that is known to the user, the user's family, and the user's friends but not known to the public or not readily accessible to the public).

As used herein, a “product” is something produced by human effort, mechanical effort, and/or a natural process. The term product can also include a service that is an act or work performed for a user and for pay.

As used herein, a “social network” is a social structure in which users communicate with each other over a network with electronic devices. The social network facilitates the building of social relations among users who share backgrounds, familial relations, business relations, interests, and/or connections. The social network includes one or more of representations and/or information about the users (such as user profiles, photos, videos, etc.) and a platform (such as a web-based platform) that allows the users to communicate with each other over one or more networks (such as using email and/or instant messages over the Internet) and/or share information with other users in the social network.

As used herein, a “third party” includes a person (such as one or more people) and/or an entity (such as a department, an electronic device, a corporation, a business, a cooperative, a partnership, or other group with whom it is possible to conduct transactions and/or business).

As used herein, a “user” is a human being, a person.

As used herein, a “user agent” is software that acts on behalf of a user. User agents include, but are not limited to, one or more of intelligent agents and/or intelligent electronic personal assistants (agents and/or assistants that use learning, reasoning and/or artificial intelligence), multi-agent systems (plural agents that communicate with each other), mobile agents (agents that move execution to different processors), autonomous agents (agents that modify processes to achieve an objective), and distributed agents (agents that execute on physically distinct electronic devices).

As used herein, a “user profile” is personal data that represents an identity of a specific person or organization. The user profile includes information pertaining to the characteristics and/or preferences of the user. Examples of this information for a person include, but are not limited to, one or more of personal data of the user (such as age, gender, race, ethnicity, religion, hobbies, interests, income, employment, education, etc.), photographs (such as photos of the user, family, friends, and/or colleagues), videos (such as videos of the user, family, friends, and/or colleagues), and user-specific data that defines the user's interaction with and/or content on an electronic device (such as display settings, application settings, network settings, stored files, downloads/uploads, browser activity, software applications, user interface or GUI activities, and/or privileges).

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

Method blocks discussed herein can be automated and executed by a computer, computer system, user agent, and/or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

What is claimed is:

1. A method executed by a user agent on an electronic device, comprising:
obtaining, by the user agent, private information about a user;
determining, by the user agent, that the private information is restricted from being disclosed to any party except the user and the user agent;
analyzing, by the user agent, the private information in order to predict a product that the user desires to purchase;
providing, by the user agent, an identity of the user and an identity of the product to an advertiser without disclosing any of the private information to a third party including the advertiser; and
displaying, on the electronic device, an advertisement for the product received from an advertiser, wherein the user agent is an intelligent personal assistant of the user.

2. The method of claim 1 further comprising:
selling, by the user agent, the identity of the user and the identity of the product to the advertiser without disclosing any of the private information to the advertiser;
playing the advertisement on the electronic device in exchange for the user receiving money from the advertiser.

3. The method of claim 1 further comprising:
grant, from the user and to the user agent, authorization to purchase products on behalf of the user;
purchase, by the user agent, the product for the user without knowledge of the user that the user agent purchases the product for the user.

4. The method of claim 1 further comprising:
disclosing, by the user agent, the identity of the user and the identity of the product to a social network to which the user is a member without disclosing any of the private information to any third party including the social network;
presenting the product at the social network to members of the social network as a recommendation for a gift for the user.

5. The method of claim 1 further comprising:
providing, via a natural language communication user interface from the user agent to the user, spoken words that identify a list of products that the user agent believes the user desires to receive;
receiving, via the natural language communication user interface from the user to the user agent, spoken words that accept a product in the list of products, reject a product in the list of products, and modify a product in the list of products.

6. The method of claim 1 further comprising:
analyzing, by the user agent, the private information in order to predict a list of products that the user desires to purchase;
receiving plural advertisements from the advertiser;
comparing, by the user agent, the plural advertisements with a list of products that the user desires to obtain; and
preventing some of the plural advertisements from being displayed to the user.

7. The method of claim 1 further comprising:
providing, by the user agent, the identity of the user and the identity of the product to another user agent of another user without disclosing any of the private information to any third party including the other user agent and the other user;
receiving the product from the other user agent as a gift from the other user to the user.

8. A computer system, comprising:
one or more memories that store instructions; and
a processing unit that executes the instructions to:
obtain, with an intelligent personal assistant of a user and from the user, private information about the user;
determine that the private information is restricted from being known by a third party except the user and the intelligent personal assistant of the user;
determine a product that the user desires based on an analysis of the private information;
disclose the user and the product to a social network to which the user is member without disclosing any of the private information to the third party including the social network and members of the social network; and
present the product at the social network to the members of the social network as a recommendation for a gift for the user.

9. The computer system of claim 8, wherein the processing unit further executes the instructions to:
provide the identity of the user and the identity of the product to an intelligent personal assistant of another user without disclosing any of the private information to the third party including the intelligent personal assistant of the other user.

10. The computer system of claim 8, wherein the processor further executes the instructions to:
purchase the product as a surprise gift for the user such that the user is not aware that the intelligent personal assistant is making the purchase of the product for the user.

11. The computer system of claim 8, wherein the processing unit further executes the instructions to:
sell the identity of the user and the identity of the product to an advertiser without disclosing any of the private information to the advertiser;
play an advertisement on the electronic device in exchange for the user receiving money from the advertiser for the identity of the user and the identity of the product.

12. The computer system of claim 8, wherein the processing unit further executes the instructions to:
display a thumbnail picture of the product on a desktop an electronic device of the user;
provide, upon receiving a click on the thumbnail picture, the private information used in the analysis to determine the product.

13. The computer system of claim 8, wherein the processing unit further executes the instructions to:
receive instructions from the user on how to improve the analysis of the private information to more accurately determine products that the user desires.

14. The computer system of claim 8, wherein the private information originates from the user when the user talks to the intelligent personal assistant of the user.

15. A non-transitory computer readable storage medium storing instructions that cause a computer system to execute a method, comprising:
obtain, with a user agent that is a personal assistant of a user and from the user, private information about user;
determine that the private information is prohibited from being known by a third party except the user and the user agent;
analyze the private information to predict a product that the user desires to purchase at a future time;
grant, from the user and to the user agent, authorization to purchase products on behalf of the user; and
purchase, by the user agent, the product for the user without knowledge of the user that the user agent purchases the product for the user and without disclosing any of the private information to a third party including an entity from whom the product is purchased.

16. The non-transitory computer readable storage medium storing instructions of claim 15 further to cause the computer system to execute the method comprising:
disclose the user and the product to a social network to which the user is member without disclosing any of the private information to the third party including the social network and members of the social network; and
present the product at the social network to the members of the social network as a recommendation for a gift for the user.

17. The non-transitory computer readable storage medium storing instructions of claim 15 further to cause the computer system to execute the method comprising:
sell an identity of the user and an identity of the product to an advertiser without disclosing any of the private information to the advertiser;
play an advertisement on an electronic device of the user in exchange for the user receiving money from the advertiser.

18. The non-transitory computer readable storage medium storing instructions of claim 15 further to cause the computer system to execute the method comprising:
analyze the private information to determine a probability greater than fifty percent that the user desires to purchase the product at the future time.

19. The non-transitory computer readable storage medium storing instructions of claim 15 further to cause the computer system to execute the method comprising:
analyze keywords extracted from a text that the user sends in order to predict the product that the user desires to purchase at the future time.

20. The non-transitory computer readable storage medium storing instructions of claim 15 further to cause the computer system to execute the method comprising:
receive the private information from the user when the user speaks to the user agent.
